(19) United States
(12) Patent Application Publication
(10) Pub. No.: US 2006/0064319 A1
(43) Pub. Date: Mar. 23, 2006

(54) Method for telemedicine services

(75) Inventor: Leo Charles Loevner, Burke, VA (US)

Correspondence Address: STEVENS DAVIS MILLER & MOSHER, LLP, 1615 L STREET, NW, SUITE 850, WASHINGTON, DC, 20036, US

(73) Assignee: T-Med Behavioral, Inc., Fairfax, VA (US)

(21) Appl. No.: 10/947,251

(22) Filed: Sep. 23, 2004

(51) Int. Cl. G06Q 10/00

(52) U.S. Cl. 705/2

(57) ABSTRACT

A method is provided for delivery of Telemedicine services that qualify for reimbursement by at least one of Medicare, Medicaid and private medical insurer. A Certified Medical Practitioner at a distant site provides service telecommunicatively to a patient located in a rented space at a qualifying originating site. Telecommunications are accomplished by one of audio and video equipment permitting two-way, real-time interactive communication between the Patient and the Certified Medical Practitioner or by asynchronous store and forward technologies, in single or multimedia formats, used as a substitute for an interactive telecommunications system. A Telepresenter is present at the originating site to facilitate the Telemedicine Session. The Telepresenter travels between originating sites or, alternatively, is provided by the originating site.

### BACKGROUND OF THE INVENTION

1. Field of the Invention

The present invention relates to a method for providing rented space, telecommunication equipment, and a Telepresenter to schedule and facilitate Telemedicine Sessions between a Patient located at an originating site and a Certified Medical Professional located at a distant site such that the Telemedicine services provided qualify for reimbursement by at least one of Medicare, Medicaid and private medical insurer.

2. Discussion of the Related Art

Many of the medical facilities in rural areas do not have access to medical consultations including psychological and psychiatric consultations. Due to this lack of services in the rural areas, Medicare and Medicaid have instituted a nationwide Telemedicine medical video teleconferencing program. The medical consultation undertaken within the scope of this teleconferencing program is considered by Medicare and Medicaid to be the same as if a Certified Medical Practitioner (Clinician) had seen the Patient in the Certified Medical Practitioner's/Professional's/Clinician's office.

Health services provided to a Patient by an off-site Certified Medical Practitioner fall into the category of ‘telehealth’. With regard to Telehealth and Telemedicine, these terms are used interchangeably throughout this specification. Telemedicine is defined as the use of telecommunications to provide medical information and services by a medical professional to a remote Patient. The technology is available to deliver such information and services, such as the clinical care of Patients, and eligibility criteria have been defined in order to qualify for reimbursement under Medicare, for example. Effective Oct. 1, 2001 section 1834 of the Social Security Act was amended to specify payment to a Physician for Telemedicine services that are furnished via telecommunications system to an eligible Telemedicine individual (see Federal Register, Vo. 66, No. 212, Thursday, Nov. 1, 2001, Rules and regulations, p. 55281 ‘F. Telehealth Services’). Many types of electronic delivery systems can be used.

Telemedicine services are defined as professional consultations, office and other outpatient visits, individual psychotherapy, pharmacologic management, and any additional service subsequently specified. An interactive telecommunications system must be used and the medical examination of the Patient must be at the control of the Physician or other Certified Medical Practitioner at a distant site. The use of telecommunications technology is considered to be an extension to normal practice. Providers using Telemedicine accept the same responsibility, are subject to the same certification and licensing requirements, undertake the same cognitive processes and are expected to provide the same quality of services as they would if they were performing the same service in-person, according the American Telemedicine Association, (‘Report on Reimbursement’, [online]. [retrieved on 2004-7-27]. Retrieved from the Internet:<URL:http://www.atmeda.org/news/Reiumburement%20White%20paperfinal.p df>).

An interactive telecommunications system is defined as multi-media communications equipment that includes, at a minimum, audio and video equipment permitting two-way, real-time interactive communication between the Patient and Physician or Certified Medical Practitioner at the distant site. Telephones, facsimile machines, and electronic mail systems do not meet the definition of an interactive telecommunications system. A Patient need not be present for a Federal Telemedicine demonstration program conducted in Alaska or Hawaii. For such Federal Telemedicine demonstration programs, payment is permitted for Telemedicine when asynchronous store and forward technologies, in single or multimedia formats, are used as a substitute for an interactive telecommunications system. Additionally, the Physician or Certified Medical Practitioner at the distant site must be affiliated with the demonstration program (see Federal Register, Vol. 66, No. 212, Thursday, Nov. 1, 2001, Rules and regulations, p. 55281 ‘F. Telehealth Services 1. Definitions’).

Asynchronous, store and forward technologies are defined as transmission of a Patient's medical information from an originating site to a Physician or Certified Medical Practitioner at a distant site such that the Physician or Certified Medical Practitioner at the distant site can review the medical case without the Patient being present. An asynchronous telecommunications system in single media format does not include telephone calls, images transmitted via facsimile machines, and text messages without visualization of the Patient (e.g., electronic mail). Photographs must be specific to the Patient's medical condition and adequate for rendering or confirming a diagnosis or treatment plan. An originating site is defined as the location of an eligible Telemedicine individual at the time a service being furnished via a telecommunications system occurs (see Federal Register, Vol. 66, No. 212, Thursday, Nov. 1, 2001, Rules and regulations, p. 55281 ‘F. Telehealth Services 1. Definitions’).

A Telepresenter is not required to be present during the time a service being furnished via a telecommunications system occurs, and is not a condition of Medicare payment. Further, Medicare payments made to the distant site Physician or Certified Medical Practitioner for professional fees, including deductible and coinsurance, are not to be shared with the Telepresenter. Non-Physician Certified Medical Practitioners include Nurse Practitioners, Physician Assistants, Clinical Nurse Specialists, Certified Nurse Midwives, Clinical Psychologists, and Clinical Social Workers and others, as approved by Medicare, Medicaid and private insurers. The Physician and Certified Medical Practitioner at the distant site who furnishes a Telemedicine service is paid an amount equal to the amount that the Physician or Certified Medical Practitioner would have been paid under Medicare had the service been furnished without the use of a telecommunications system.

No payment by Medicare is made for line charges, but a facility fee payment to the originating site of 80 percent of the lesser of the actual charge or the facility Originating fee, which changes yearly. An originating site is defined as Physician's or Certified Medical Practitioner's office, hospital, critical access hospital, rural health clinic or Federally qualified health center (see Federal Register, Vol. 66, No. 212, Thursday, Nov. 1, 2001, Rules and regulations, p. 55282 ‘F. Telehealth Services 1. Definitions’).

Telemedicine is coming of age. Medical Practitioners are getting ‘wired’ in novel ways to benefit Patients, according to the Telemedicine Research Center (About Telemedicine: What is Telemedicine? [online]. [retrieved on 2004-02-04}. Retrieved from the Internet: <URL: http://trc.telemed.org/Telemedicine/primer.asp>).

Published Patent Application U.S. 2003/002842 A1 by Burak et al., the entire contents of which are hereby incorporated by reference, discloses a method and apparatus for accounting and billing for telecommunicatively rendered services where the Patient initiates the request for services and specifies how billing is to be done. Paragraph [0013] discloses:
“The invention further envisions extension of the concepts to provide low cost video for billable Telemedicine where medical advice will be rendered via video teleconference connections. The invention further embraces instant referrals within the medical care system, the storage and viewing of Patient history over the worldwide web and Bluetooth or Palm computer links to telemetry appliances for routine monitoring of Patient vital signs while the Patient is at home.”

The invention of Burak et al. envisions presenting multiple payment options to the Patient, including credit card payment, direct fund transfers, and automatic invoicing of the Patient and third party payor.

Published Patent Application U.S. 2003/0231238 A1 to Chew et al., the entire contents of which are hereby incorporated by reference, discloses a mobile videoconferencing system. Paragraphs [0057] and [0058], respectively, disclose:
“The mobile unit could be used as a mobile “doctor's office”. With the aid of Registered Nurses or trained medical technicians, the doctors back at the offices or hospital could visually and electronically, diagnose and administer care for many different groups of people (nursing homes, elderly care facilities, children's homes, under-privileged families, special education facilities, and many more). Doctor signed prescriptions and other documentation could also be completed. This scenario maximizes doctor efficiency, minimizing hospital expenses for doctor travel time and off campus expenses. Diagnostic accuracy is enhanced by the interactive and real-time video and audio from the Patient and attending staff.
Rural medicine in general has great needs for Telemedicine. The current problem is that rural doctors do not have broadband capabilities at their rural locations. The mobile unit may be deployed to link with hospitals or rural offices to supply the care and doctor specialty that may be lacking within this scenario. The mobile unit delivers the doctor care and expertise needed to help these Patients . . . .”

However, the invention of Chew et al. does not include “rented space” in which to provide services within an originating site/facility and Patients have to be moved from the originating site/facility to the mobile unit in order to receive services.

Published patent application U.S. 2002/0198473 A1 by Kumar et al., the entire contents of which are hereby incorporated by reference, discloses a system and method for real-time monitoring, assessment, analysis, retrieval, and storage of physiological data over a wide area network. Paragraphs [0209] and [0276], respectively, disclose:
“The web based real-time streaming of vital signs and audio/video data along with central storage and retrieval features provided by a system according to one embodiment are ideal for remote cardiac rehabilitation and cardiac monitoring for sectors like home-care, nursing homes, assisted living facilities for elders and other applications like remote health monitoring on aircraft and ships.”
“Generally, cardiologists cannot charge insurance when their Patients call them over the phone complaining about their chest pain. With web-enabled devices, not only can they provide better services to their Patients, but they can also charge the insurance for real-time interpretation of the ECG/event monitor signals. The system can be adapted to automate and web enable health provider protocols for ECG/pacemaker/ICD interpretations so that they can offer their protocols to other cardiologists for a fee.”

The invention of Kumar et al., requires at least one Patient-side device for the collection of physiological data from a Patient and a provider-side device to receive the data from the at least one Patient-side device over a wide area network (Abstract). While Kumar et al. disclose a system and method for acquiring, assessing, analyzing, storing and retrieving physiological data over a wide area network, there is no disclosure of renting space or having a Telepresenter as a traveling technician or a medical circuit rider, or leaving only some of the equipment at the originating site.

Thus, the concept of providing Telemedicine Services is old in the art. However, a Telemedicine system and method that provides rented space in an originating site, provides some or all video teleconferencing equipment at the rented space at the originating site, and/or provides a Telemedicine Home Office and a Telepresenter as a facilitator for scheduling and conducting Telemedicine Sessions that qualify for payment by Medicare, Medicaid or other Medical insurance is not known in the art.

### SUMMARY OF THE INVENTION

The method of the present invention provides a “rented” space along with some or all of the video teleconferencing equipment required to enable a Certified Medical Professional at a distant site to conduct a Telemedicine Session that qualifies for payment by Medicare, Medicaid or by an Insurance provider.

The present invention provides a “rented” space in an originating site wherein a telecommunications system may substitute for a face-to-face, “hands on” encounter for at least one service selected from the group consisting of consultation, office visit, individual psychotherapy and pharmacologic management, wherein the at least one service is provided by a distant site Certified Medical Professional, i.e., a Physician, Psychiatrist or a Certified Medical Practitioner, such as a Psychologist or Psychiatric Nurse Practitioner.

According to one aspect of the invention, space in an originating site is “rented” for a consideration and some or all of the video conferencing equipment, required to conduct a Telemedicine Session from the originating site by distant site Certified Medical Professional, is provided at the “rented” originating site. For example, a sample “Lease” is included in Appendix A. Thereafter, either on a regularly scheduled basis or on demand, a visiting technician (termed a Telepresenter) schedules Telemedicine Sessions, operates the video teleconferencing equipment in the “rented” space and facilitates Telemedicine Sessions in the “rented” space. In this way, the distant site medical professional can provide information and services to a Patient and the services provided can qualify for reimbursement by at least one of Medicare, Medicaid and Insurance providers. The Telepresenter is a level 1 skilled technician and performs functions that are the equivalent of a medical circuit rider facilitating pre-scheduled and ad hoc Telemedicine Sessions in “rented” space of at least one originating site.

A level 1 skilled technician is defined as one that will make no medical decisions but only prepare the records and paperwork for the distant site medical professional and record results of a Telemedicine Session for originating site 101 personnel to implement, distant site 106 personnel to receive and record, and for a Telemedicine Home Office 111 to capture in a Telemedicine Database/Archive 112. The level 1 skilled technician is skilled and knowledgeable in operating the video-teleconferencing equipment, conducting a video-teleconferencing session and in applying operating procedures to:

answer questions;

schedule video-conferencing sessions;

schedule Patients for video-conferencing sessions;

determine eligibility for a requested Telemedicine service;

assemble Patient charts in their required order and sequence;

record a variety of distant Certified Medical Practitioner's orders for Patient activities, diets, tests, and treatment resulting from a Telemedicine Session;

relay distant site Certified Medical Practitioner's instructions to Patients and originating site Certified Medical Practitioners;

relay information to the originating site Certified Medical Practitioners regarding the Patient's condition;

compile/submit data on Patients treated to be recorded in the Telemedicine Database/Archive 112;

operate video-conferencing equipment;

facilitate Telemedicine Sessions; and

code diagnostic and operative/procedural information resulting from a Telemedicine Session.

A nurse or other certified paramedical professional may also be located at the originating site 101 to assist in obtaining information to relay to the distant site Certified Medical Practitioner 107 but a nurse or other paramedical professional is not required to qualify a Telemedicine Session for reimbursement by Medicare or Medicaid. Distant site Certified Medical Practitioners 107 bill for their telecommunicatively provided services as if provided in-person using appropriate CPT codes with a GT modifier.

In an alternative embodiment the Video Teleconferencing equipment is permanently located in an originating site and no one transports all or a part of the video conferencing to and from the originating site. For example, the originating site hires personnel through the facility where a patient is a resident to function as a Telepresenter at the originating site. Appendix B is an example of an agreement between the resident's facility and the originating site for Telepresenter services to be provided by personnel of the resident's facility.

In another aspect of the invention, artifacts of a Telemedicine Session are captured electronically to an automated persistent store, such as an electronic database, e.g., Telemedicine Database/Archive 112. Once captured, these artifacts can be retained, transmitted and archived in video, audio and digital formats. This capture is especially important for billing Medicare, Medicaid and Insurance providers for reimbursement of Telemedicine Services provided to a Patient. Therefore, the level 1 skilled technician must further be skilled and knowledgeable in:

determining eligibility requirements for Medicare, Medicaid and Insurance reimbursement;

determining Patient eligibility for Medicare, Medicaid and Insurance reimbursement;

laws and regulations related to the confidentiality of medical records and the release of information from medical records;

coding diagnostic and procedural information using Current Procedural Terminology (CPT) codes with GT modifier; and

computerized data entry and information systems sufficient to create, access and maintain the Patient records and Telemedicine Session documentation in standard formats, using pre-determined forms and in electronic data stores.

In another aspect, the present invention comprises an automated persistent store for retaining historical data for each Telemedicine Session. Retention and purging of these historical data can be controlled locally and/or remotely and these historical data can be locally and/or remotely maintained, manipulated and displayed.

### BRIEF DESCRIPTION OF THE DRAWINGS

FIG. 1 illustrates a typical Telemedicine Session, according to an embodiment of the present invention;

FIG. 2 is an overview of a Telepresenter visiting originating sites, on a regularly scheduled basis or on demand, to deliver information and facilitate provision of Telemedicine Services to Patients;

FIG. 3 illustrates a high level flow of delivering information and services telecommunicatively and billing Medicare, Medicaid, and Medical Insurance providers for these services;

FIG. 4 illustrates a form for collecting information resulting from a first or diagnostic interview examination;

FIG. 5 illustrates a form for collecting information resulting from an established Patient consultation;

FIGS. 6A-B illustrate information collected and provided to a distant site medical professional in preparation for a Telemedicine Session;

FIGS. 7A-B illustrate a Telepresenter responsibilities checklist; and

FIG. 8 illustrates a Telemedicine Provider responsibilities checklist.

FIG. 9 illustrates a typical system for managing Telemedicine services.

### DETAILED DESCRIPTION

In the following discussions for purposes of clarity with respect to explaining the current invention, common components are numbered according to their first appearance in a drawing and well-known components are to be interpreted according to the understanding of a person ordinarily skilled in the art.

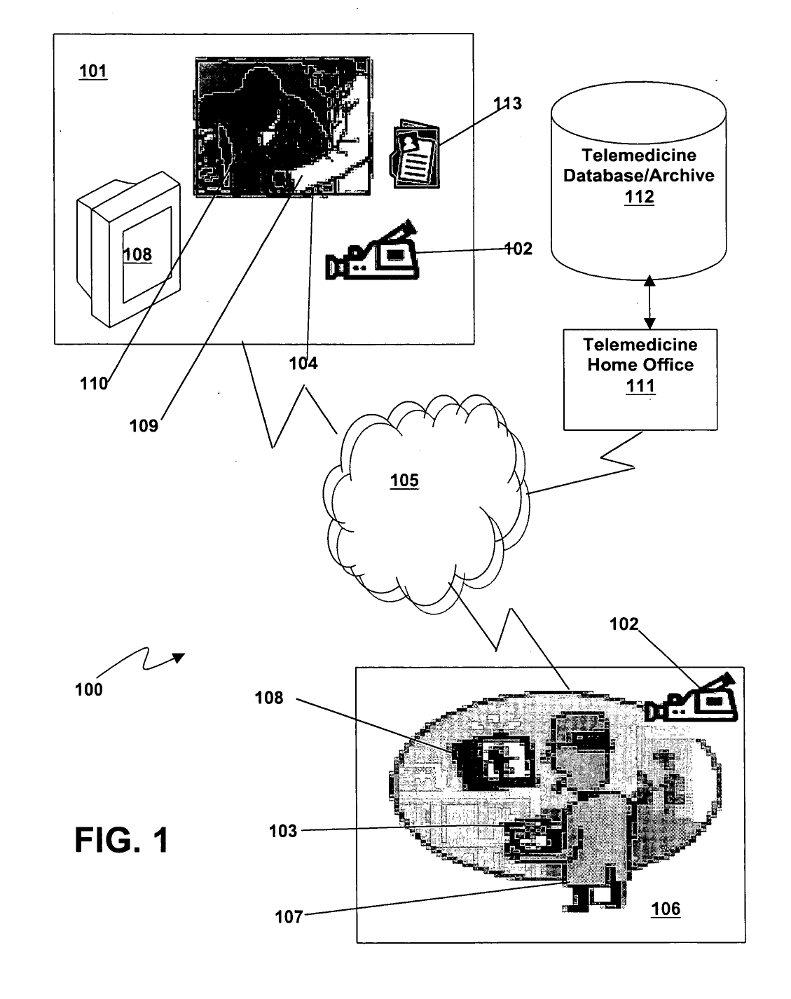

Referring now to FIGS. 1-6, the method of the present invention provides a Telemedicine Home Office 111 that “rents” space 101 in at least one originating site, provides a level 1 Medical Technician as a Telepresenter 109 to conduct at least one Telemedicine Session 100 between the at least one originating site 101 and at least one distant site 106, maintains a database and archive 112 of Telemedicine related information 400 500 600 as well as provides access to the Telemedicine Database/Archive 112. For Example, in FIG. 1, the Internet or ISDN telephone lines 105 are the access method provided.

The “rented” space 101 is the location of an eligible Medicare, Medicaid and Insurance beneficiary, i.e., Patient, at the time a service being furnished via a telecommunications system occurs.

The distant site 106 is the location of a Certified Medical Professional 107 providing the services telecommunicatively. As illustrated in FIG. 1, the distant site 106 and the originating site 101 have 2-way video teleconferencing equipment, such as, video displays 108 and cameras 102, the originating site 101 may telemeter vital signs (not shown) to the distant site 106 for display on a monitor 103 or medical files 113 provided by the originating site 101 or the Telemedicine Home Office 111 obtained from the database 112 may be transmitted to the distant site 106 and displayed on the monitor 103. 2-way audio is also provided but is not shown in FIG. 1.

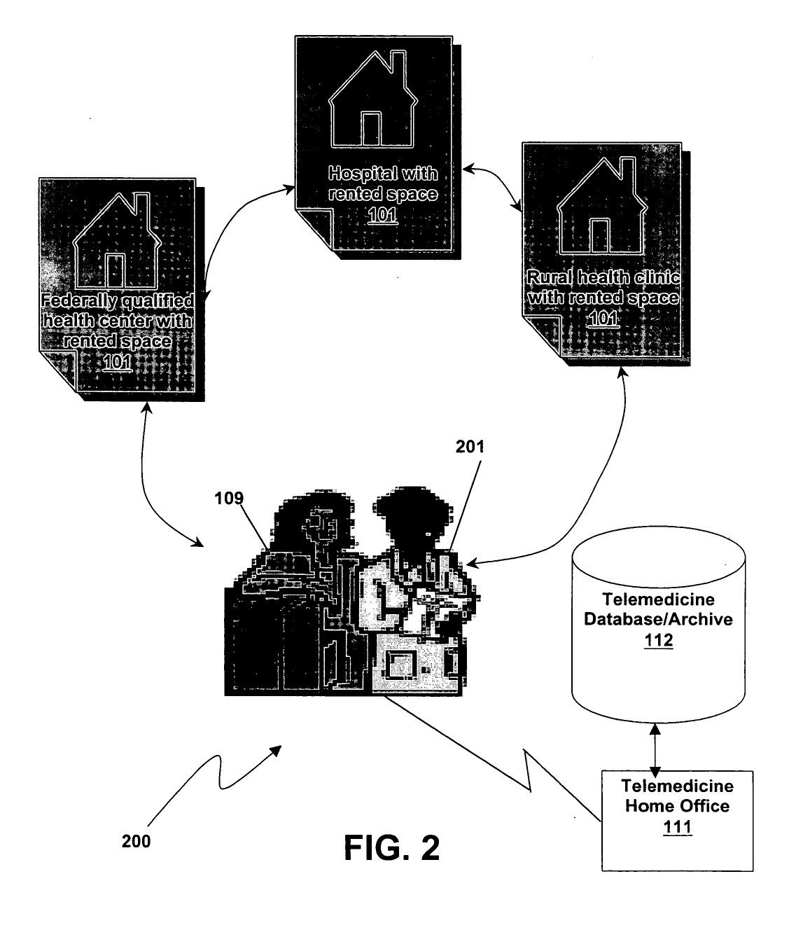

As illustrated in FIG. 2, the Telepresenter 109 facilitates scheduling by either visiting or contacting the at least one originating site 101 and maintaining schedules by communicating with the Telemedicine Home Office 111, retrieving, updating and storing schedules in the Telemedicine Database/Archive 112. The schedules can be created and called up on demand and modified by personnel at an originating site 101, a distant site 106, the Telemedicine Home Office 111, authorized originating site personnel 201, authorized distant site personnel, and by a Telepresenter 109. Access to the Telemedicine Database/Archive 112 can be from any appropriately configured device having network access 105 (FIG. 1) including a personal digital assistant, a laptop computer, a personal computer (PC), a workstation and a server. Access can be wireless or wired, via landline or satellite and even by dial-up to reach very remote originating sites. Authorized personnel include Certified Medical Professionals and selected ones of their support staff that are specifically authorized to access the Telemedicine Database/Archive 112. Support staff are not illustrated in the drawings. A Telepresenter is not required to present a Patient to a Physician or Certified Medical Practitioner at the distant site.

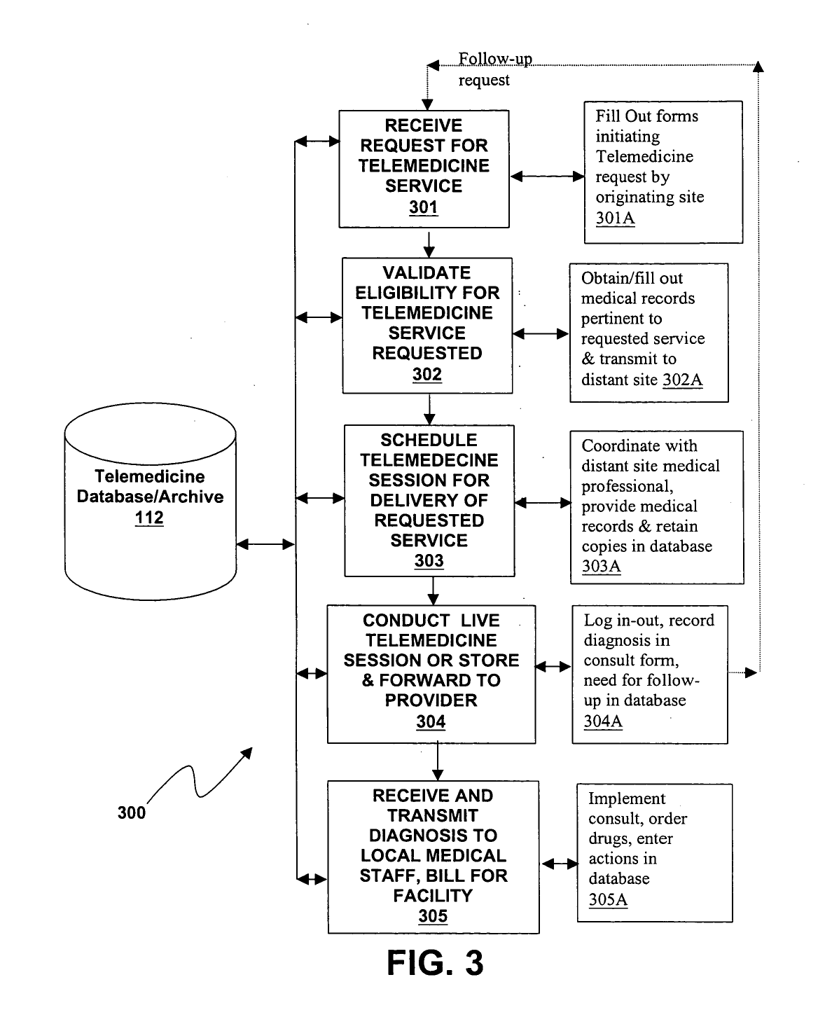

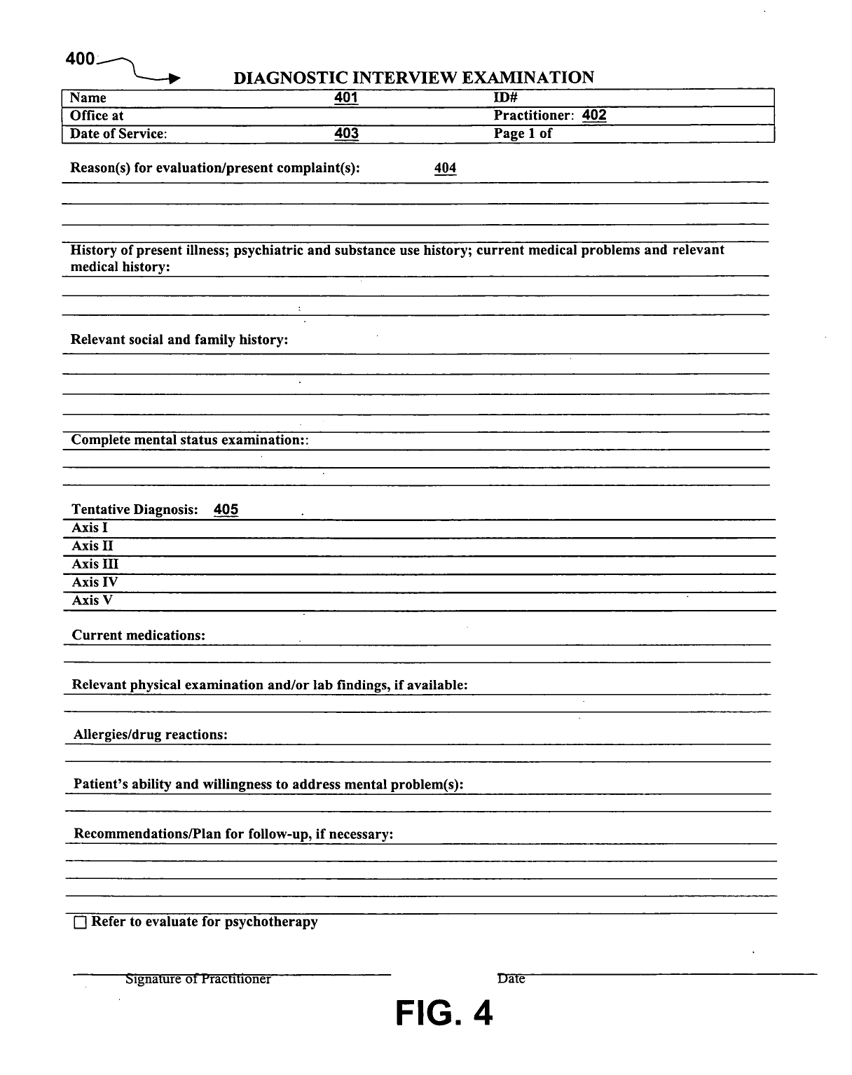

Referring now to FIG. 3, a Telepresenter or the Telemedicine Home Office 111 receives a request for a Telemedicine Service at step 301 from the at least one originating site 101 for at least one Patient. At least one of a Telepresenter 109 or the Telemedicine Home Office 111 validates the eligibility of the at least one Patient for the requested Telemedicine service at step 302 and obtains medical records pertinent to the requested Telemedicine Service at step 302A and stored these records in the Telemedicine Database/Archive 112 for access by Telepresenter, originating and distant site authorized personnel and originating and distant site Certified Medical Professionals. The type of Telemedicine Service determines the length of time required and schedules for the requesting originating site 101 are examined for an open time slot of this length. The distant site 106 must also be considered for availability not only of the time slot but for the availability of the Certified Medical Professional to provide the requested Telemedicine Service. Suitable coordination 303A is accomplished by at least one of the Telepresenter 109 and the Telemedicine Home Office 111 and a mutually agreeable time slot is scheduled 303. The agreed upon scheduled time slot is entered into the Telemedicine Database/Archive 112 and all parties involved receive confirmation notices and reminder notices, appropriately timed and sent by the Telemedicine Home Office 112. At the scheduled time slot, a Telepresenter 109 travels to the originating site 101 and conducts either a live Telemedicine Session or creates and stores in the Telemedicine Database/Archive 112 or other suitable storage medium, a store and forward Telemedicine Session that is downloaded by or otherwise sent to a scheduled distant site Certified Medical Professional 107 at step 304. Appropriate forms are completed, including a log of conducted Telemedicine Sessions 304A and the information content of the forms (see FIGS. 4-6) is stored in the Telemedicine Database/Archive 112. Finally, at step 305 any diagnosis is received from the distant site Certified Medical Professional 107 and conveyed to originating site Certified Medical Professional 201. Billing is then accomplished for the facility and for the provided Telemedicine services at step 305.

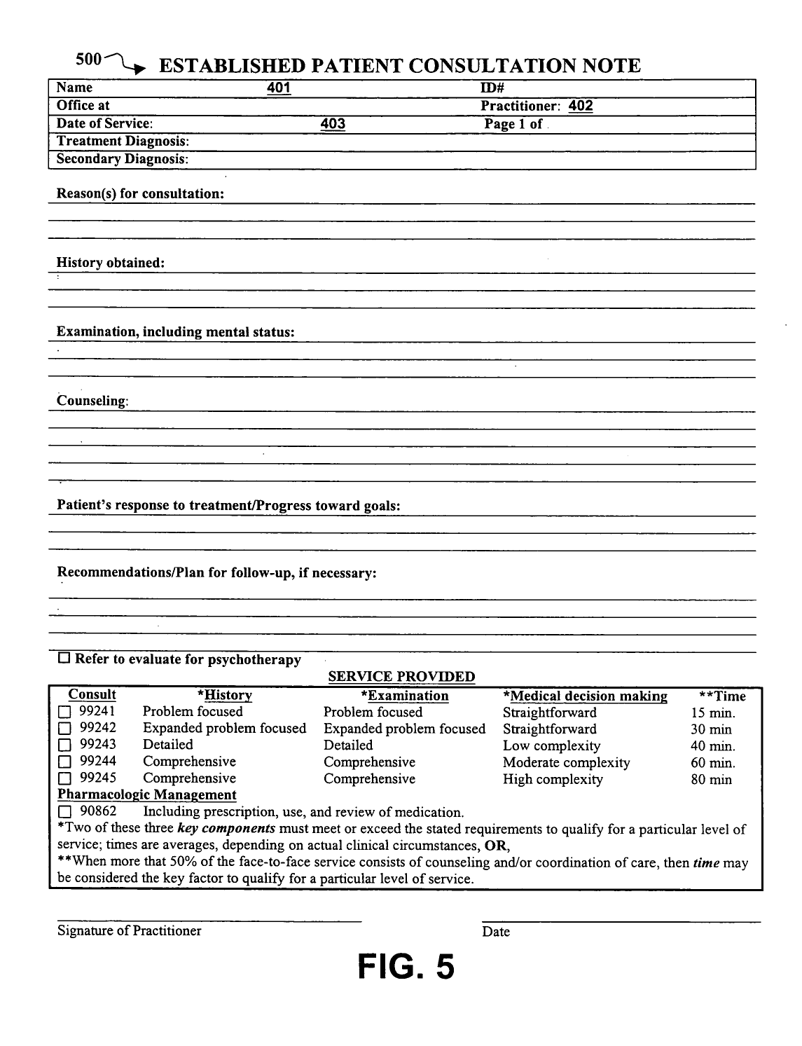

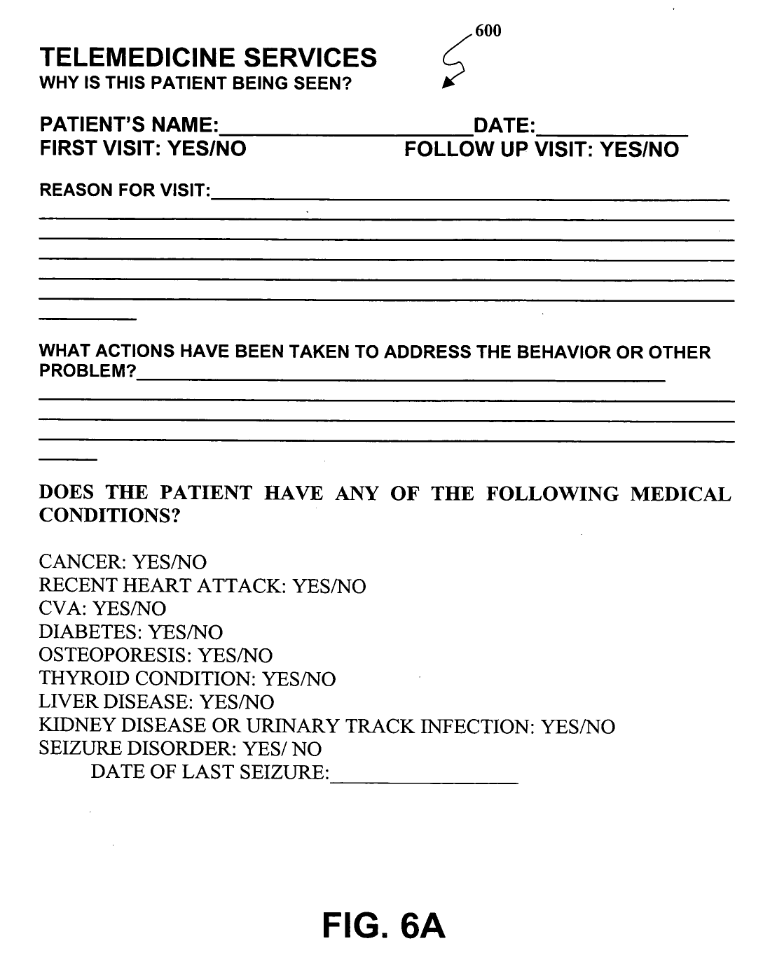

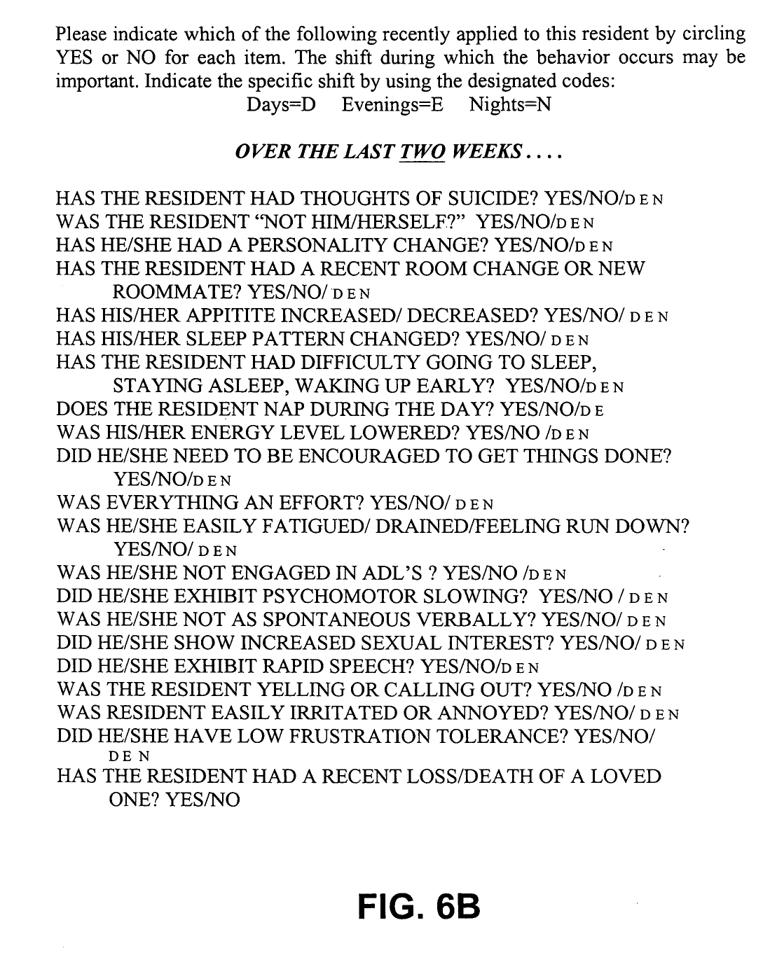

Typically, several forms are used to collect information regarding Telemedicine services being provided. FIG. 4 shows a ‘Diagnostic Interview Examination’ form 400 having a number of spaces 401-405 (and others) for filling-in information about a new Telemedicine patient, FIG. 5 shows an ‘Established Patient Consultation Note’ 500 having spaces 401-403 (and other spaces) for filling-in information, and FIGS. 6A-6B show a typical form for providing background information to the Telemedicine Services Provider.

The Telemedicine Home Office maintains a telecommunicatively accessible computer system to manage scheduling of Telemedicine Sessions, maintain and provide access to the Telemedicine database/archive 112, record and transmit ‘store and forward’ Telemedicine sessions, and to bill for use of the facility and provided Telemedicine Service. The telecommunicative access provided can be any or all of dial-up, wired or wireless network, Internet, and satellite link.

An originating site includes:
a Physician's or Certified Medical Practitioner's office;
a hospital;
a critical access hospital;
a rural health clinic; and
a federally qualified health center.

A distant site means a site where the Physician or Certified Medical Practitioner providing the professional service via a teleconference is located at the time the service is provided via a telecommunications system.

According to one aspect of the invention, space in an originating site is “rented” for a consideration and some or all of the video conferencing equipment required to conduct a Telemedicine Session from an originating site by a Certified Medical Professional located at a distant site is provided at the originating site. An example of a typical lease for “rented” space is contained in Appendix A.

Along with “rented” space at an originating site, the method of the present invention provides some or all of the video teleconferencing equipment required to enable a distant Certified Medical Professional to conduct a Telemedicine Session that qualifies for payment by at least one of Medicare, Medicaid and an Insurance provider.

In a preferred embodiment, the Telemedicine Home Office 111 of the present invention provides a “rented” space in an originating site 101 wherein a telecommunications system may substitute for a face-to-face, “hands-on” encounter for services such as consultation, office visits, individual psychotherapy and pharmacologic management. These qualifying (for payment by Medicare, Medicaid, and other Medical insurer) Telemedicine Services include:
Consultations;
Office or other out-Patient visits;
Individual psychotherapy; and
Pharmocologic management.

Once space in a qualifying originating site has been rented or otherwise reserved for Telemedicine purposes, either on a regularly scheduled basis or on demand, a visiting Telepresenter 109 operates video teleconferencing equipment in the “rented” space. In this way, a distant site Certified Medical Professional provides information and services to a remote Patient. The visiting Telepresenter 109 is a level 1 skilled technician and performs the functions of a Telemedicine circuit rider by traveling from one originating site to another to facilitate Telemedicine sessions therein. Alternatively, personnel hired by the originating site perform the functions of a Telepresenter 109 according to a contractual arrangement, see, e.g., the agreement in Appendix B, and are reimbursed for their services in this regard.

In one aspect of the present invention, interactive audio and video telecommunications are used, permitting real-time communication between the distant site Physician or Certified Medical Practitioner and the Patient. The Patient is present and participating in the Telemedicine Session.

In another aspect of the present invention, asynchronous ‘store and forward technology’, in single and multimedia formats, is used as a substitute for an interactive telecommunications system. For purposes of this invention, store and forward includes the asynchronous transmission of medical information to be reviewed at a later time by a Physician or Certified Medical Practitioner 107 at a distant site 106. A Patient's medical information may include, but is not limited to, video clips, still images, x-rays, MRIs, EKGs and EEGs, laboratory results, audio clips, and text. The Physician or Certified Medical Practitioner 107 at the distant site reviews the case without the Patient being present. Store and forward substitutes for an interactive encounter with a Patient since the Patient is not present in real-time. If photographs are presented they are specific to a Patient's condition and adequate for rendering or confirming a diagnosis and/or treatment plan. Dermatological photographs, for example, are considered to meet the requirement of a single media format.

General Telemedicine Services Flow

Given the foregoing definitions and by way of illustration and not limitation, a general flow for Telemedicine Services, according to an embodiment of the present invention, begins with the originating site 101 determining that a Patient needs to be “seen” by a distant site Certified Medical Professional. Referring to FIG. 3, the following steps are performed in accordance with the method of the present invention:

requesting a doctor's order for nursing home residents and some Assisted living residents as required by the facilities to see the resident for medical services at step 301;

filling out the paper work provided by a Telepresenter 109 as to the medical/psychiatric condition of a Patient, see FIGS. 6A-B for examples of forms at step 301A;

providing at step 302A
1. a fact sheet on the Patient to be seen,
2. HIPPA paperwork on each Patient,
3. a signed Patient authorization for billing purposes, if needed, and
4. a signed Telemedicine authorization form;

communicating all of the above to the distant site at step 302A;

a Telepresenter 109 or the Telemedicine Home Office 111 scheduling a day and time for provision of Telemedicine Services at step 303;

at the scheduled time on the schedule date, the Telepresenter performing at step 304 the substeps
1. setting up the video conferencing equipment,
2. establishing a 2-way video conferencing communications connection with a distant site over one of the group selected from ISDN lines, the Internet, a satellite and transmission service, and
3. if a store and forward Teleconferencing Session is to be recorded, recording the session and transmitting the session to a prescheduled distant site 106;

once a link has been established or a store and forward session has been recorded and transmitted, the medical personnel at the distant site beginning the provision of Telemedicine Services by reviewing the information communicated to them and beginning discussions with the resident and the facility nurse present at each Telemedicine Session at step 304;

the Telepresenter keeping a record of who is provided what Telemedicine services for purposes of billing Medicare, Medicaid and third party insurances for the Facility Fee provided Telemedicine Services at step 304A;

making a diagnostic decision by the distant site Certified Medical Professional 107 at step 304;

filling out a consultation form, e.g., FIG. 5, by the distant site Certified Medical Professional 107 at step 304;

communicating the consultation form 500 to the originating site that includes the diagnosis, nurses orders and, if appropriate, a suggestion to an originating site Certified Medical Professional 201 for medication at step 305;

approving the medication by the originating site Certified Medical Professional 201 at step 305;

if the originating site Certified Medical Professional 201 approves the consultation form, the originating site Certified Medical Professional 201 implementing the orders on the consultation form 500 including ordering any prescription drugs at step 305A; and

billing at least one of Medicare, Medicaid or third party insurance for the consultation and facility fee using a third party commercial billing system at step 305.

Telepresenter Flow

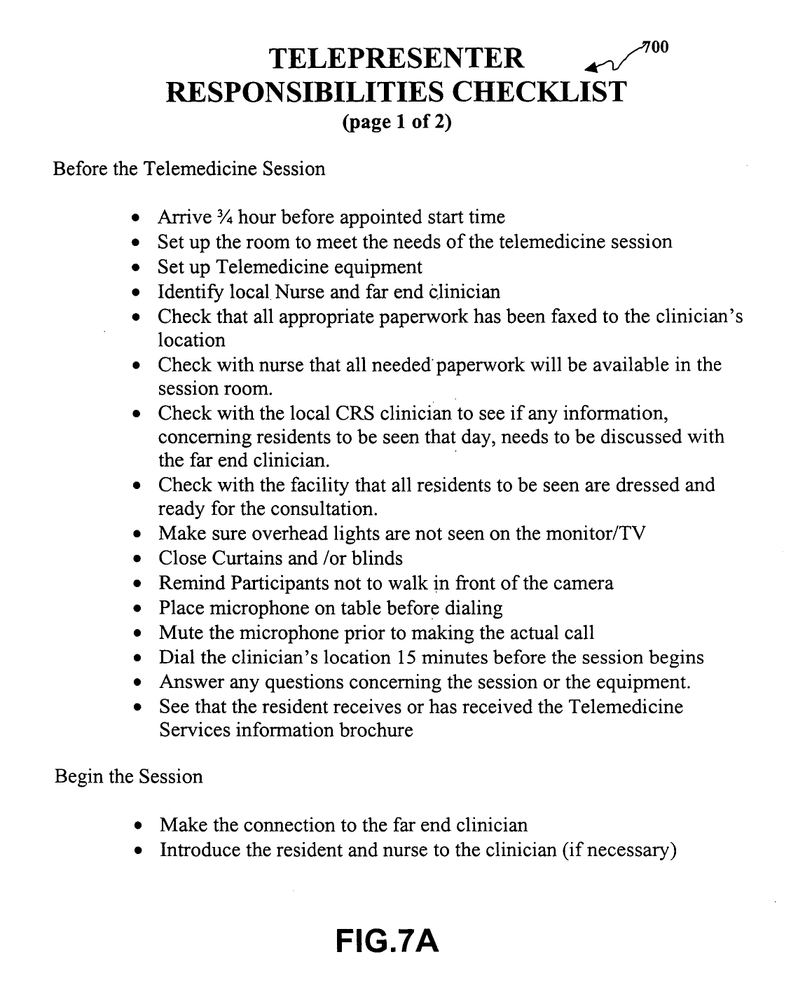

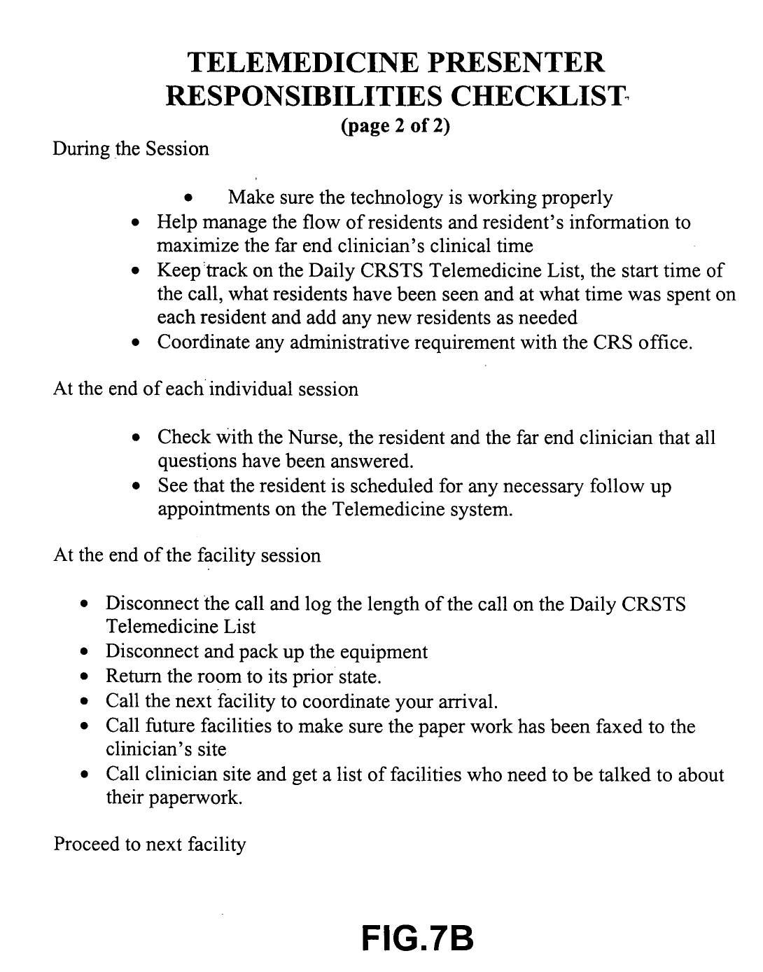

As an example only, referring now to the checklist 700 of FIGS. 7A-B, for a visit to an originating site, such as rented clinician's office in a Nursing Home, typically a Telepresenter performs the following steps:

A. Before the Telemedicine Session

arriving a pre-determined amount of time before appointed start time;

setting up a rented space and Telemedicine equipment to meet the needs of the Telemedicine Session;

identifying an originating site Certified Medical Professional 201 and a distant site Certified Medical Professional 107;

checking that all appropriate paperwork has been communicated to the Certified Medical Professional 107 at the distant site 106;

checking that all needed paperwork is available in the “rented” space of the originating site 101;

checking with the originating site Certified Medical Professional 201 to see if any information, concerning Patients to be seen that day, needs to be discussed with the distant site Certified Medical Professional;

checking with the originating site 101 that all Patients to be seen are ready for a Telemedicine consultation;

making sure overhead lights are not visible to the camera

closing curtains and/or blinds;

reminding participants not to walk in front of the camera;

placing microphone(s) on table(s) before connecting;

muting the microphone prior to establishing the connection;

connecting to distant site location a predetermined amount of time prior to the start of the Telemedicine Session; and

answering any questions concerning the Telemedicine Session or the equipment.

B. Begin the Telemedicine Session

establishing a connection to a scheduled distant site 101; and

introducing a Patient and optionally a Certified Medical Professional associated with the originating site to the distant site Certified Medical Professional (if necessary).

C. During the Telemedicine Session

determining that communications and 2-way video teleconferencing technology being used during the session is working properly;

managing the flow of Patients and Patients' information to maximize the distant site Certified Medical Professional's time;

keeping track on a Daily Telemedicine Log, the start time of the Telemedicine Session, what Patients have been seen and what time was spent with each resident, adding any new Patients as needed; and

coordinating any administrative requirement with the Telemedicine Home Office 111.

D. At the End of Each Individual Telemedicine Session

checking with the originating site Certified Medical Professional 201 and the distant site Certified Medical Professional 107 that all questions have been answered; and

making certain that the distant site medical professional 201 is scheduled for any necessary follow up Telemedicine Session(s).

E. At the End of Each Facility Session

terminating the Telemedicine Session and logging the duration of the Telemedicine Session in a Daily Telemedicine Log and in the Telemedicine Database/Archive 112;

disconnecting and optionally packing up the video teleconferencing equipment;

returning the ‘rented’ space to its state prior to conducting the Telemedicine Session(s);

contacting the next originating site 101 to coordinate the arrival of the Telepresenter 109;

contacting future originating sites 101 to make sure required paperwork has been received by the distant site Certified Medical Professional; and

contacting the distant site Certified Medical Professional 107 to obtain a list of originating sites 101 for which paperwork is needed.

F. Proceed to the Next Facility

Once all schedule Telemedicine Sessions have been conducted at a given originating site 101, the Telepresenter 109 proceeds to the next originating site 101.

A nurse or other paramedical professional 201 may also be located at the originating site 101 to assist in obtaining information to relay to the distant site Certified Medical Professional 107.

Telemedicine Provider Flow (Distant Site Certified Medical Professional)

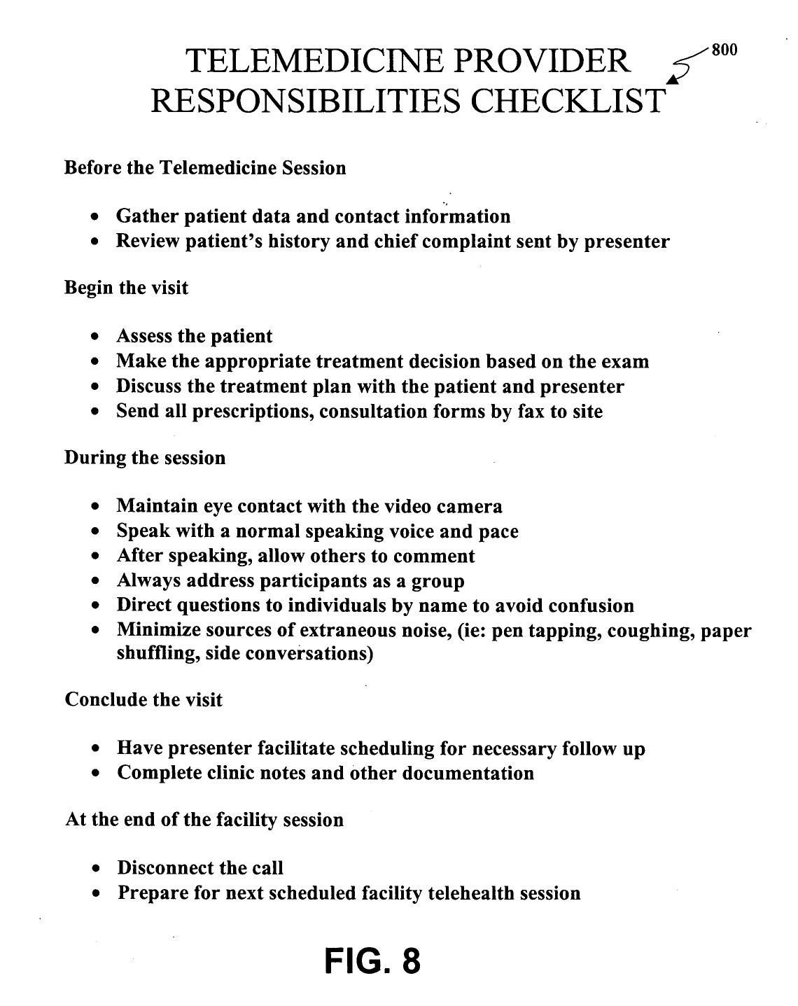

As an example only, referring now to the checklist 800 of FIG. 8, typically a Telemedicine Provider performs the following steps:

A. Before the Telemedicine Session

obtaining Patient data and contact information; and

reviewing Patient's history and chief complaint sent by a Telepresenter 109.

B. Begin the Visit

assessing a Patient;

making an appropriate treatment decision based on the assessment;

discussing the treatment plan with the Patient and, if present, a Telemedicine Presenter 201 (a Certified Medical Professional located at the originating site 101 and different from the Telepresenter 109 who is a level 1 technician); and

communicating all prescriptions, consultation forms 500 to the originating site 101 at which the Patient is located, e.g., by fax.

C. During the Telemedicine Session

maintaining eye contact with the camera;

speaking with a normal speaking voice and pace;

after speaking, allowing others to comment;

always addressing participants as a group;

directing questions to individuals by name to avoid confusion; and

minimizing sources of extraneous noise, (i.e., pen tapping, coughing, paper shuffling, side conversations).

D. Concluding a Telemedicine Session

Telepresenter 109 scheduling any necessary follow up; and

completing clinical notes and other documentation.

E. At the End of the Facility Session

terminating the Telemedicine Session; and

preparing for next scheduled Telemedicine Session.

In another aspect of the invention, artifacts of a video teleconference are captured in a persistent store, such as a Telemedicine Database/Archive 112. Once captured, these artifacts can be retained, transmitted and archived in video, audio and digital formats. This capture is especially important for billing Medicare, Medicaid and Medical Insurance providers for reimbursement.

In order to facilitate payment for services, conditions that must be satisfied for payment are incorporated into the present invention as Telemedicine practice rules. For example, in order for Medicare payment to occur, interactive audio and video telecommunications must be used that permit real-time communication between the distant site Physician or Certified Medical Practitioner and the Medicare beneficiary. There are exceptions to this Telemedicine practice rule, for example, in the case of Federal Telemedicine demonstration programs conducted in certain states.

The method of the present invention governs the provision of Telemedicine services in a manner that conforms to the requirements of the payor for such service, e.g., private Medical Insurance provider and Medicare.

Business Eligibility Criteria;

Coverage of Telemedicine—only reimbursed for services normally covered when provided in-person;

Payment methodology for Physician/Certified Medical Practitioner at a distant site—same as in-person;

Originating site facility fee payment methodology—currently $20/Telemedicine Session; and

Submission of Telemedicine claims—Claims for professional consultations, office visits, individual psychotherapy, and pharmacologic management provided via a telecommunications system are submitted to the carrier that processes claims for the performing Physician/Certified Medical Practitioner's service area. Physicians/Certified Medical Practitioners submit the appropriate CPT procedure code for covered professional telehealth services along with the “GT” modifier (“via interactive audio and video telecommunications system”). By coding and billing the “GT” modifier with a covered telehealth procedure code, the distant site Physician/Certified Medical Practitioner certifies that the beneficiary was present at an eligible originating site when the telehealth service was furnished.

To claim the facility payment, Physicians/Certified Medical Practitioners will bill HCPCS code “Q3014, telehealth originating site facility fee”; short description “telehealth facility fee.” The type of service for the telehealth originating site facility fee is “9, other items and services.” For carrier-processed claims, the “office” place of service (code 11) is the only payable setting for code Q3014. There is no participation payment differential for code Q3014 and it is not priced off of the Medicare Physician Fee Schedule Database file. Deductible and coinsurance rules apply to Q3014. By submitting HCPCS code “Q3014”, the biller certifies that the originating site is located in either a rural HPSA or a non-MSA county.

Physicians and Certified Medical Practitioners at the distant site bill their local Medicare carrier for covered telehealth services, for example, “99245 GT”. Physicians' and Certified Medical Practitioners' offices serving as a telehealth-originating site bill their local Medicare carrier for the originating site facility fee.

Exception for store and forward (non-interactive) telehealth.—In the case of Federal Telemedicine demonstration programs conducted in Alaska or Hawaii, store and forward technologies may be used as a substitute for an interactive telecommunications system. Covered store and forward telehealth services are billed with the “GQ” modifier, “via asynchronous telecommunications system.” By using the “GQ” modifier, the distant site Physician/Certified Medical Practitioner certifies that the asynchronous medical file was collected and transmitted to them at their distant site from a Federal Telemedicine demonstration project conducted in Alaska or Hawaii.

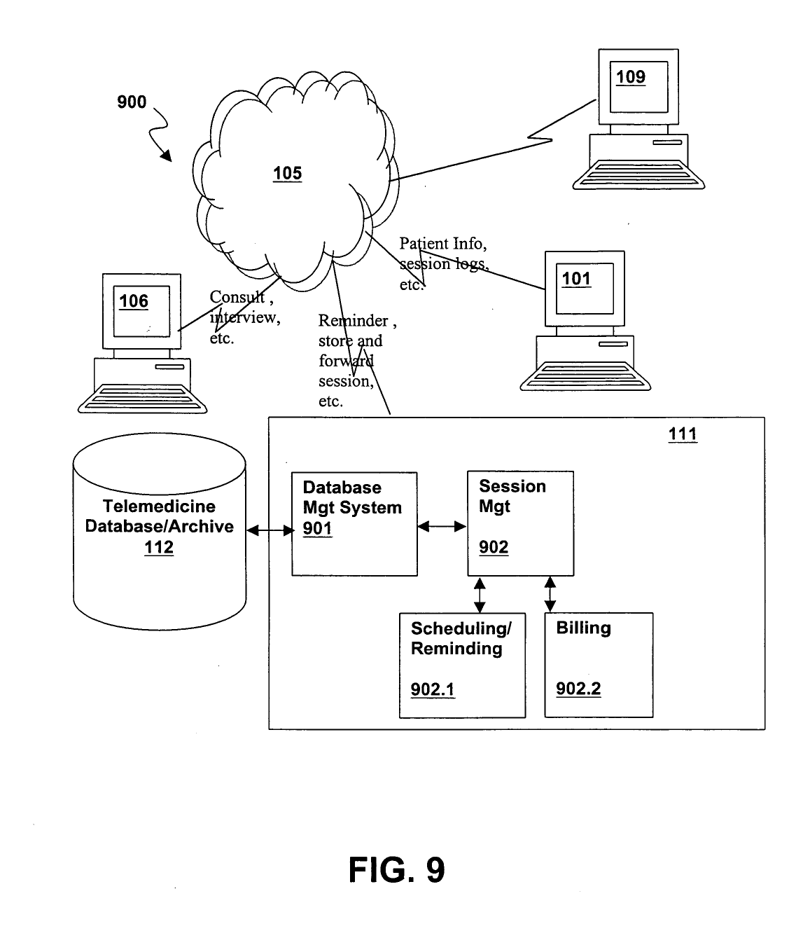

FIG. 9 illustrates a typical networked system 900 for managing an providing Telemedicine services. Such a networked system 900 typically comprises components networked together by a network 105 (such as the Internet) wherein the components includes at least one originating site 106, at least one distant site 109, at least one Telemedicine Home Office 111 having at least one Telemedicine Database/Archive 112. The Telemedicine Home Office 11 typically includes subsystems or components for Database Management 901, Telemedicine Session Management 902 that further includes at least Scheduling/Reminding component 902.1 and billing component 902.2.

While preferred embodiments have been shown and described, various modifications and substitutions may be made thereto without departing from the spirit and scope of the present invention. Accordingly, the present invention is limited to the scope of the appended claims, and the present invention has been described by way of illustrations and not limitations.

[image]

[image]

[image]

[image]

[image]

[image]

[image]

[image]

[image]

I claim:

1. A method for delivery and reimbursement for at least one qualifying Telemedicine service provided by a Telemedicine provider, comprising the steps of:
providing space and equipment by a Telemedicine provider for a Telemedicine Session in at least one originating site;
a Telepresenter facilitating a pre-scheduled Telemedicine Session between the at least one originating site and the Telemedicine provider located at a distant site to deliver the at least one qualifying Telemedicine service to at least one Patient located in the provided space;
obtaining reimbursement for the delivered at least one Telemedicine service.

2. The method of claim 1, wherein Telemedicine services comprise professional consultations, office and other outpatient visits, individual psychotherapy, and pharmacologic management.

3. The method of claim 1, wherein the Telemedicine provider is a Certified Medical Practitioner selected from the group consisting of Physician, Clinical Psychologist, Nurse Practitioner, Physician Assistant, Nurse Midwife, Clinical Nurse Specialist, Clinical Social Worker.

4. The method of claim 1, wherein the at least one originating site is a plurality of originating sites and the at least one Telepresenter travels between said plurality of originating sites.

5. The method of claim 1, wherein:
the Patient resides in a resident's facility; and
further comprising the step of providing the Telepresenter by the resident's facility.

6. The method of claim 1, wherein the obtaining reimbursement step further comprises the steps of:
coding the at least one Telemedicine service provided using CPT codes with GT modifier; and
billing at least one of the group consisting of Medicare, Medicaid, and medical insurer for an originating site facility use fee and the at least one Telemedicine service provided.

7. The method of claim 1, wherein the at least one originating site is selected from the group consisting of a rural nursing home, a rural assisted living facility, and a rural continuing care retirement community.

8. The method of claim 1, wherein the providing equipment step further comprises one of the steps selected from the group consisting of:
permanently locating all the provided equipment in the provided space for a Telemedicine session,
permanently locating a part of the provided equipment in the provided space and bringing in part of the provided equipment to the provided space for a Telemedicine Session, and
bringing in all the equipment to the provided space for a Telemedicine Session.

9. The method of claim 1, wherein:
the provided space is rented in the at least one originating site;
the provided equipment comprises Telemedicine and video equipment; and
further comprising the step of using the provided Telemedicine and video conferencing equipment by a Telemedicine provider at a distant site to deliver the at least one Telemedicine service to at least one Patient at the at least one originating site.

10. The method of claim 9, wherein the video equipment comprises an interactive telecommunications system including audio and video equipment permitting two-way, real-time interactive communication between the Patient and the Telemedicine provider, and an asynchronous store and forward technology in at least one of a single or multimedia format.

11. The method of claim 9, wherein the rented space is selected from the group consisting of a rural nursing home, a rural assisted living facility, and a rural continuing care retirement community.

12. The method of claim 11, wherein the video equipment comprises an interactive telecommunications system including audio and video equipment permitting two-way, real-time interactive communication between the Patient and the Telemedicine provider, and an asynchronous store and forward technology in at least one of a single or multimedia format.

13. The method of claim 10, wherein the providing equipment step further comprises one of the steps selected from the group consisting of:
permanently locating all the provided equipment in the provided space for a Telemedicine session,
permanently locating a part of the provided equipment in the provided space and bringing in part of the provided equipment to the provided space for a Telemedicine Session, and
bringing in all the equipment to the provided space for a Telemedicine session.

14. The method of claim 1, wherein the step of facilitating further comprises the steps of:
if the provided equipment is partially brought in, bringing a part of the provided equipment in to the originating site;
connecting the provided equipment in the provided space to the distant site;
monitoring interaction between the Telemedicine provider at the distant site and the Patient at the originating site;
receiving diagnosis and other results from the Telemedicine provider;
conveying diagnosis and other results to at least one of the Patient and a local Medical facility for implementation
recording diagnosis and other results of the pre-scheduled Telemedicine session.

15. The method of claim 14, wherein connecting is by means of one of the group consisting of modem, satellite, Internet, ISDN, LAN, WAN.

16. The method of claim 14, further comprising the steps of:
receiving a request for at least one Telemedicine service for at least one Patient from at least one originating site;
certifying the at least one Patient's eligibility for reimbursement, for the requested at least one Telemedicine service, by at least one of the group consisting of Medicare, Medicaid, and medical insurer;
transmitting each certified Patient's relevant medical records to the distant site Telemedicine provider; and
pre-scheduling the at least one originating site space and distant site Telemedicine provider for a Telemedicine session.

17. The method of claim 16, further comprising the steps of:
when a Telemedicine session uses asynchronous store and forward technology, performing the steps of:
recording the Telemedicine session;
forwarding the recorded Telemedicine session to the Telemedicine provider at the distant site; and
receiving a diagnosis from the Telemedicine provider for the forwarded Telemedicine session.

18. The method of claim 17, further comprising the steps of:
providing a database;
maintaining medical records for the at least one Patient medical in the provided database; and
storing the request, schedule, session, and diagnosis of the Telemedicine session in the provided database.

19. The method of claim 18, wherein connecting is by means of one of the group consisting of modem, satellite, Internet, ISDN, LAN, WAN.
